(19) United States
(12) Patent Application Publication
(10) Pub. No.: US 2014/0237567 A1
(43) Pub. Date: Aug. 21, 2014

(54) AUTHENTICATION METHOD

(71) Applicant: ChannelPace Pty Ltd, Mt. Waverley (AU)

(72) Inventors: Greg Furlong, Mt. Waverley (AU); Larry Lewis, Mt. Waverley (AU)

(73) Assignee: ChannelPace Pty Ltd, Mt. Waverley (AU)

(21) Appl. No.: 14/179,676

(22) Filed: Feb. 13, 2014

(30) Foreign Application Priority Data
Feb. 19, 2013 (AU) 2013900541

(51) Int. Cl. H04L 29/06

(52) U.S. Cl. CPC H04L 63/083
USPC 726/6

(57) ABSTRACT

An improved authentication method for authenticating user identity for access to a computer service.

### FIELD OF THE INVENTION

The present invention relates to an improved authentication method for authenticating user identity and allowing access to a computer service.

### BACKGROUND OF THE INVENTION

With the rapid development of the Internet, email, and similar web-based technologies, there has been a corresponding increase in access to, and dissemination of, information.

The ready availability of information has led to the development of a number of authentication methods to ensure the security of information and to prevent unauthorized access to information sources and computer services available or maintained on a computer network.

A computer network is a collection of computer hardware, storage, software and interfaces interconnected by communication channels to allow a sharing of resources and information. Computer network(s) can be used in a manner to provide on-demand computer services such as the delivery of software, infrastructure and data storage over the Internet. Numerous services can be hosted on a computer network, including, for example, services in the form of a database directed to professional networking.

An authentication method may be incorporated as part of a computer service to identify the user and validate access to the information contained within the computer service. This is particularly important where sensitive data or functionalities are held and/or controlled by the computer service. The potential loss and/or loss of control over sensitive data may lead to considerable loss and damage for the holder of the data. It may also be important where the computer service is provided on a subscription payment basis at a cost per user.

Password-based authentication methods are a commonly used and basic mode of authentication. Passwords can include numbers, character combinations, encrypted terms or email addresses.

However, these forms of authentication pose a number of risks. For example, a password may be readily guessed or intercepted by an unauthorized party then stolen and used to gain access to sensitive information including using a remote computer. This makes the origin of the unauthorized access difficult to trace, intercept and prosecute. Additional risks may be encountered where the information accessed by an unauthorized party can be readily disseminated in an uncontrolled manner to other unauthorized persons and/or used for unauthorized purposes.

Also, given the increased usage and reliance on computer services and varying password requirements, users may have a multitude of relevant passwords which can lead to less than secure passwords (for example, “guest” or “abc123”) and/or the passwords being recorded insecurely (for example, a sticky note adjacent to a computer terminal).

Multi-factor authentication techniques are also commonly used for access to computer services and the information contained therein. Multi-factor authentication, for example, uses two or more authentication factors based on:
(i) something the user knows (for example, a password, personal identification number or the answer to a pre-determined question such as “country of birth?”);
(ii) something the user has (for example, mobile device); or
(iii) something the user is (for example, a biometric characteristic).

It is considered that the requirement for the combination of these authentication factors decreases the likelihood that the user is falsely attributing identification information to the computer service, and thereby reducing the likelihood of unauthorized access to the computer service.

However, it is still possible for unscrupulous operators to use devious means to obtain information necessary to permit unauthorized access to a computer service, even with the requirement of multi-factor authentication techniques. For example, the password may be known and the unscrupulous person may have obtained access to the mobile device allowing a benefit to be derived from access to the computer service.

In addition, an individual might use a computer service as part of their employment, for example, for professional networking or Customer Relationship Management (CRM), but still is able to access that service after ceasing that employment role as the authentication method is separate from or not able to be controlled by the employer.

It is therefore an object of the present invention to overcome or substantially ameliorate one or more disadvantages of the prior art. In particular, one object of the invention is to provide an improved authentication method for authenticating user identity for access to a computer service using a single-factor approach.

It should be understood that any reference to prior art does not constitute an admission of common general knowledge.

### SUMMARY OF THE INVENTION

In an aspect of the present invention there is provided a method for authenticating user identity for access to a computer service, the method comprising:
storing an authorized electronic mail address associated with a user with the computer service;
receiving the electronic mail address from the user in communication with the computer service;
validating the electronic mail address;
generating a random access code;
sending an electronic mail message containing the random access code to the electronic mail address; and
receiving the random access code from the user; and
thereby allowing the user to access the computer service,
wherein the electronic mail address is authorized by an organization associated with the user.

In another aspect of the present invention there is provided a method for authenticating user identity for access to a computer service, the method comprising:
storing an authorized electronic mail address associated with a user with the computer service;
receiving the electronic mail address from the user in communication with the computer service;
validating the electronic mail address;
generating a link which allows access to the computer service; and
sending an electronic mail message containing the link to the electronic mail address,
   wherein the electronic mail address is authorized by an organization associated with the user.

In a further aspect of the invention there is provided a method for authenticating user identity for access to a computer service, the method consisting essentially of:
storing an authorized electronic mail address associated with a user with the computer service;
receiving the electronic mail address from the user in communication with the computer service;
validating the electronic mail address;
generating a random access code and a link either of which allows access to the computer service; and
sending an electronic mail message containing the random access code and the link to the electronic mail address,
wherein the electronic mail address is authorized by an organization associated with the user.

In yet another aspect of the present invention there is provided a method for authenticating user identity for access to a computer service, the method including:
a computer service;
a computer network operated by an organization;
an electronic mail address authorized by the organization and associated with a user, the electronic mail address providing the user with access to the computer network and capable of interacting with the computer service; and
a unique identifier generated by the computer service and associated with the electronic mail address of the user,
wherein in an operating condition the recipient can access the computer service by reference to the unique identifier.

The unique identifier may be a random access code or a link.

In a preferred embodiment, the local name of the electronic mail address reflects the name of the individual user.

In a further preferred embodiment, the domain name of the electronic mail address reflects the name of the organization.

In a preferred embodiment, the computer system is a cloud-based service. In a further preferred embodiment, the computer service is directed to a professional networking database.

In validating the electronic mail address, the computer service may inform the user that an electronic mail message has been sent to the electronic mail address for verification. In one embodiment, the electronic mail message includes a random access code that may consist of variable lengths of alpha-numeric values of variable length. The random access code may be a personal identification number (PIN).

In the method of the present invention the electronic mail address authorized by the organization permits access by the user to the computer service. The computer service may include a professional networking database. The computer service may allow the user to share information with other users of the computer service associated with the same organization. The user may be authorized to access the computer service for a pre-determined period commencing when the electronic mail message is sent to the electronic mail address. The pre-determined period may be determined by the organization associated with the user that authorized the electronic mail address.

In the event the recipient is no longer authorized to access or use the electronic mail address, the recipient no longer has access to the computer service.

### BRIEF DESCRIPTION OF THE DRAWINGS

For a better understanding of the invention, and to show how it may be carried into effect, embodiments of it are shown, by way of non-limiting example only, in the accompanying drawings. In the drawings:

FIG. 1 illustrates an example of the concept of the present invention and the information flow for access to the computer service including registration.

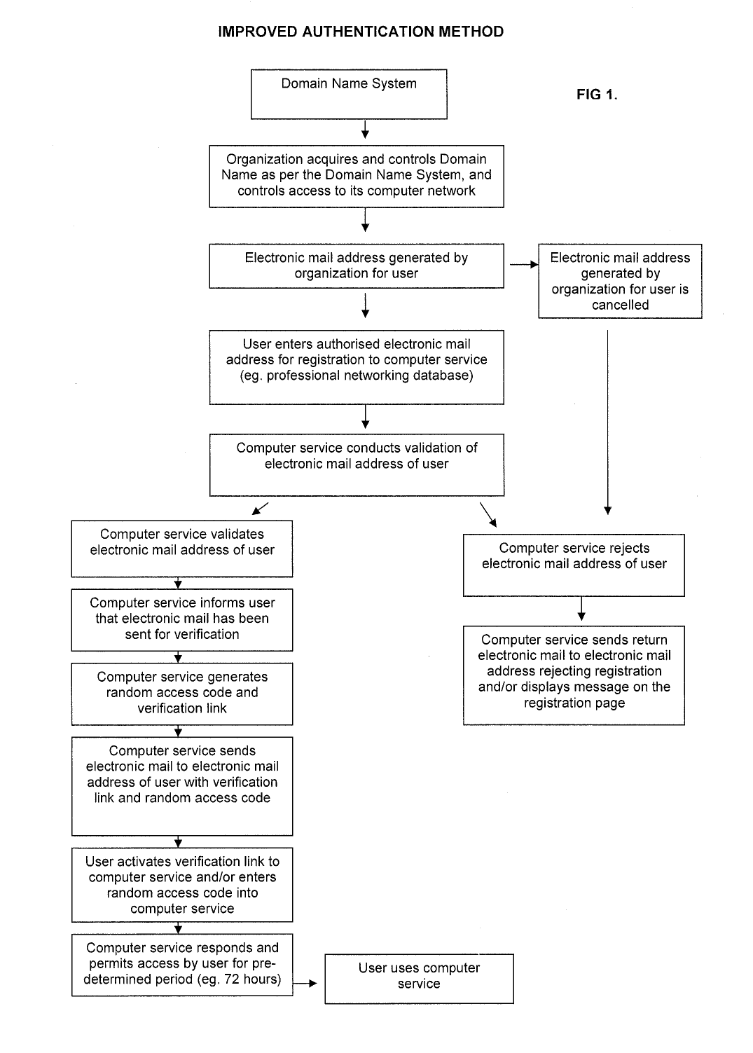

### DESCRIPTION OF PREFERRED EMBODIMENTS OF THE INVENTION

In a particularly preferred embodiment, the invention is directed to an authentication method whereby the user is an employee or contractor of the organisation that authorizes the user's electronic mail address. In any case, the underlying validity of the authentication method is dependent on the electronic mail system operated and managed by the organisation (whether in-house or by a related entity or third party contractor).

By way of background, an electronic mail address identifies a defined pathway for the receipt of electronic mail. An electronic mail address is generally recognised as having two components joined by the ‘@’ symbol.

The component before the ‘@’ symbol is commonly referred to as the ‘local part’ of the electronic mail address and is frequently utilised in computer services as the username of the user.

The component after the ‘@’ symbol is commonly referred to as the ‘domain name’ of the electronic mail address and represents the location or system of resources where the electronic mail is intended to be delivered. The domain name is the identification string which associates the computer hardware, software and other resources connected to a computer network, including the Internet, by the domain name holder.

The domain name is licensed to the domain name holder by designated authorities for each domain. The domain name holder (or its parent company or other controlling person/entity) has the ability to control access to, and use of, the computer hardware, software and other resources linked to the domain name. This includes the generation of electronic mail addresses allowing the domain name holder an internal validation opportunity to ensure authorized access to its computer networks.

Control of a domain name licence therefore corresponds to control (whether direct or indirect) of the particular computer resource used to receive electronic mail with that domain name. The electronic mail address represents an established and secure authentication mechanism controlled by the organization that controls the domain name licence, whether that is the named holder of the domain name or, for example, its parent company.

In the invention the subject of the present application, the organization that controls the domain name authorises the generation of an electronic mail address for the user associated with the organization. In a preferred embodiment, the local name of the electronic mail address reflects the name of the user.

In a further preferred embodiment, the domain name itself reflects the name of the organization. Preferably the organization is a company.

In a preferred embodiment, access to the computer service is through self-registration by the user. Alternatively, the organisation that authorises the electronic mail address associated with the user may register the user. The organisation may register more than one user at a time.

When self-registering, the user locates the registration page associated with the main interface website of the computer service. In a preferred embodiment, the computer service is a cloud-based service. In a further preferred embodiment, the computer service is directed to a professional networking database.

In the preferred self-registration embodiment, the recipient completes the registration process using the authorized electronic mail address authorized by the organization. In a preferred embodiment, the domain name is not a free electronic mail service such as, for example, ‘@hotmail’, ‘@yahoo’ or similar. In a further preferred embodiment, the electronic mail address is not suspicious, dubious, disapproved or otherwise blacklisted by the operator of the computer service. In another embodiment, the electronic mail address is not already listed with the computer service meaning a new registration is required.

The computer service conducts analysis to confirm the validity of the electronic mail address entered by the user.

If the computer service considers the electronic mail address to be invalid or not active, an electronic mail notification is sent to the user and/or a message is displayed to the user on the registration page and the user is not able to register for access to the computer service.

If the computer service considers the electronic mail address to be valid, the user is informed that an electronic mail message has been sent to the electronic mail address for verification. In one embodiment, the user is informed through notification on the user interface for the computer service. In another embodiment, an electronic mail message is sent to the user informing them that an electronic mail message for verification has been sent to their electronic mail address.

The computer service generates an electronic mail message for verification. In one embodiment, the electronic mail message for verification includes a random access code. The random access code may be alpha-numeric. The random access code may be a personal identification number (PIN).

In another embodiment, the electronic mail message includes a link which allows access to the computer service.

In a further embodiment, the electronic mail message includes a random access code and a link either of which allows access to the computer service.

The recipient accesses the electronic mail message for verification and engages the verification link or the recipient enters the random access code into the computer service.

Once registration is verified, the authorized electronic mail address associated with the user is stored with the computer service. Subsequent access to the computer system requires the user to enter the authorized electronic mail address into the computer service. The computer service validates the electronic mail address and generates a random access code and/or a link, either of which allows access to the computer service. The computer service sends an electronic mail message containing the random access code/or and the link to the electronic mail address.

The user may be authorized to access the computer service for a predetermined period. In a preferred embodiment, the pre-determined period is determined by the organization associated with the user that authorized the electronic mail address. In an alternate embodiment, the predetermined period is 72 hours.

It can be seen from the above method that if the electronic mail address of the user is no longer authorized by the organization, the user will no longer have access to the computer service. The organization therefore provides authentication for access to the computer service.

A reference to any prior art in this specification is not, and should not be taken as, an acknowledgment or any form of suggestion that the referenced prior art forms part of the common general knowledge, whether in Australia or elsewhere.

Throughout this specification, the words “comprise”, “comprised”, “comprising” and “comprises” are to be taken to specify the presence of stated features, integers, steps or components but does not preclude the presence or addition of one or more other features, integers, steps, components or groups thereof.

In the claims, each dependent claim is to be read as being within the scope of its parent claim or claims, in the sense that a dependent claim is not to be interpreted as infringed unless its parent claims are also infringed.

The claims defining the invention are as follows:

1. A method for authenticating user identity for access to a computer service, the method comprising:
storing an authorized electronic mail address associated with a user with the computer service;
receiving the electronic mail address from the user in communication with the computer service;
validating the electronic mail address;
generating a random access code;
sending an electronic mail message containing the random access code to the electronic mail address; and
receiving the random access code from the user; and
thereby allowing the user to access the computer service,
wherein the electronic mail address is authorized by an organization associated with the user.

2. The method according to claim 1, wherein the random access code is a personal identification number (PIN).

3. The method according to claim 1, wherein the computer service is a professional networking database.

4. The method according to claim 1, wherein the user is authorized to access the computer service for a pre-determined period commencing when the electronic mail message is sent to the electronic mail address.

5. The method according to claim 4, wherein the pre-determined period is determined by the organization associated with the user that authorized the electronic mail address.

6. The method according to claim 1, wherein the computer service allows the user to share information with other users of the computer service associated with the same organization.

7. A method for authenticating user identity for access to a computer service, the method comprising:
storing an authorized electronic mail address associated with a user with the computer service;
receiving the electronic mail address from the user in communication with the computer service;
validating the electronic mail address;
generating a link which allows access to the computer service; and
sending an electronic mail message containing the link to the electronic mail address,
wherein the electronic mail address is authorized by an organization associated with the user.

8. The method according to claim 7, wherein the computer service is a professional networking database.

9. The method according to claim 7, wherein the user is authorized to access the computer service for a pre-determined period commencing when the electronic mail message is sent to the electronic mail address.

10. The method according to claim 9, wherein the pre-determined period is determined by the organization associated with the user that authorized the electronic mail address.

11. The method according to claim 7, wherein the computer service allows the user to share information with other users of the computer service associated with the same organization.

12. A method for authenticating user identity for access to a computer service, the method consisting essentially of:
storing an authorized electronic mail address associated with a user with the computer service;
receiving the electronic mail address from the user in communication with the computer service;
validating the electronic mail address;
generating a random access code and a link either of which allows access to the computer service; and
sending an electronic mail message containing the random access code and the link to the electronic mail address,
wherein the electronic mail address is authorized by an organization associated with the user.

13. The method according to claim 12, wherein the random access code is a personal identification number (PIN).

14. The method according to claim 12, wherein the computer service is a professional networking database.

15. The method according to claim 12, wherein the user is authorized to access the computer service for a pre-determined period commencing when the electronic mail message is sent to the electronic mail address.

16. The method according to claim 15, wherein the pre-determined period is determined by the organization associated with the user that authorized the electronic mail address.

17. The method according to claim 12, wherein the computer service allows the user to share information with other users of the computer service associated with the same organization.
